(19) United States
(12) Patent Application Publication
(10) Pub. No.: US 2004/0164255 A1
(43) Pub. Date: Aug. 26, 2004

(54) Radioactive sources

(76) Inventor: Mark Golder Shilton, Chelmsford, MA (US)

Correspondence Address: William H Holt, Law Offices of William H Holt, First Floor Unit 2, 1423 Powhatan Street, Alexandria, VA, 22314, US

(21) Appl. No.: 10/482,658

(22) PCT Filed: Jun. 4, 2003
(86) PCT No.: PCT/GB03/02456

(30) Foreign Application Priority Data
Jun. 15, 2002 (GB) 0213854.3

(51) Int. Cl. G21G 4/00

(52) U.S. Cl. 250/493.1

(57) ABSTRACT

Radioactive sources are made from a foil (10) containing radioactive material, by cutting out hexagonal foil elements (12) from the foil, leaving no uncut portions of foil between adjacent hexagonal foil elements. This significantly induces wastage of radioactive foil.

This invention relates to a radioactive source, and to a method of making the source.

Radioactive sources, particularly those used in smoke detectors, may contain radioactive material embedded in a foil of non-radioactive material. For example americium may be provided in the form of a 1 μm thick layer of americium oxide/gold composite, covered by say a 2 μm thick layer of gold, and supported on a laminated silver substrate of thickness say 150 μm. The substrate ensures that the foil is easy to handle. Such a laminated foil may be made by repeated rolling, with repeated addition of backing layers. Small sources can then be punched out of the laminated foil, and located in holders.

According to the present invention there is provided a method of making a multiplicity of radioactive sources from a foil containing radioactive material, by cutting out a multiplicity of hexagonal foil elements from the foil, leaving no uncut portions of foil between adjacent hexagonal foil elements.

Conventional cutting out procedures leave uncut portions of foil between adjacent foil elements, because the foil elements are circular. By making hexagonal foil elements, the foil elements can be from contiguous parts of the foil, and no gaps need be left between them. Consequently the present invention leads to much reduced wastage of the radioactive foil.

A preferred method of cutting out the hexagonal foil elements entails first punching out alternate lines of hexagonal foil elements, leaving intervening uncut strips with zigzag sides; and then cutting across the uncut strips to form hexagonal foil elements.

Preferably each hexagonal foil element is subsequently located in a holder. It is preferably located in a recess, and may be secured in position by crimping the wall of the recess. If the recess is circular this may entail at least five crimped positions around the wall, or alternatively the entire circumference of the wall may be crimped over.

The invention will now be further and more particularly described, by way of example only, and with reference to the accompanying drawings in which:

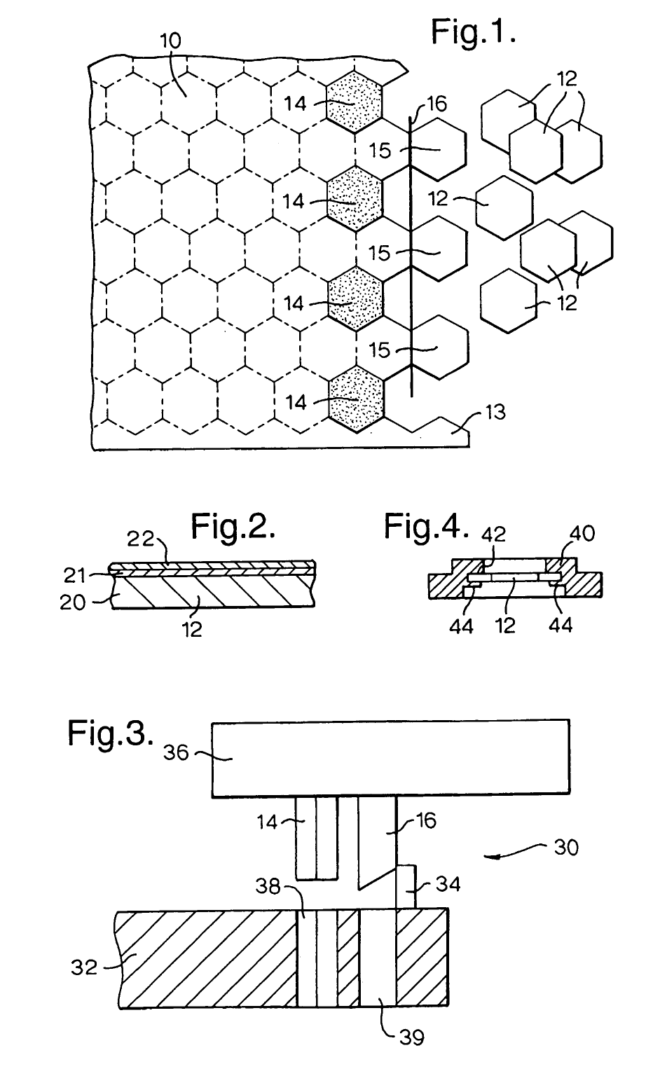

FIG. 1 shows a plan view illustrating how the foil is cut to form foil elements;

FIG. 2 shows a sectional view through a foil element;

FIG. 3 shows a side elevation of a tool for cutting out the foil elements; and

FIG. 4 shows a longitudinal sectional view through a source incorporating a foil element.

Referring now to FIG. 1, this illustrates diagrammatically how the foil is to be cut. A sheet of foil 10 containing radioactive material is to be cut so that at least the bulk of the foil is cut up to form hexagonal foil elements 12 which were initially contiguous, so that no gaps are left between adjacent foil elements 12. The drawing shows a part of the foil 10, showing the lines along which it is intended to cut the foil 10 as broken lines, although it will be appreciated that no such lines would appear on the foil 10. The foil 10 is initially rectangular, and along the edges there are uncut strips 13. In this example a row of hexagonal punches 14 is arranged to cut out a row of spaced-apart foil elements 12 across the entire width of the foil 10 so leaving projecting strips 15 of uncut foil with zigzag sides. A cutting tool 16 is then arranged to cut off the ends of the projecting strips 15, so cutting off hexagonal foil elements 12. The foil 10 is then moved forwards (to the right, in the drawing) by a distance equal to the width of a foil element 12, and the punches 14 activated to cut out the next row of spaced-apart foil elements 12, and the cutting tool 16 activated to cut off the next set of ends of the projecting strips 15. This procedure is then performed repeatedly to cut the entire foil 10 into foil elements 12.

Referring now to FIG. 2, which shows part of a foil element 12 in cross-section (not to scale), the foil element 12 consists of a laminated foil 20 of silver of thickness 125 μm, on whose upper surface is a 1 μm thick layer 21 of americium oxide/gold composite, covered by a gold layer 22 of thickness 2 μm, these thicknesses being by way of example. Each foil element 12 might for example be of width 2 mm (between opposite parallel sides) and contain 0.25 μg of americium-241, which is an alpha-emitter with a half life of about 430 years. The activity of such a source is about 0.9 pCi. The gold layer 22 is sufficiently thin not to significantly reduce the emission of alpha particles. The foil 10 from which the foil element 12 is cut out may be made by a repeated rolling procedure, or a combination of rolling and electrode position.

Referring now to FIG. 3, this shows somewhat diagrammatically, and partly in section, a side view of a tool or mechanism 30 for cutting out the foil elements 12. The foil 10 (not shown in FIG. 3) is fed along the top surface of a steel plate 32. (from the left, as shown) so that its end abuts an end stop 34. A cutting mechanism 36 pushes down a set of hexagonal punches 14 and a cutting blade 16, so they mate with corresponding hexagonal apertures 38 and a rectangular slot 39 in the plate 32 respectively. As they mate with the apertures 38 and the slot 39 they cut out the foil elements 12 in the manner described in relation to FIG. 1, and the elements 12 fall down through the apertures 38 and the slot 39 to emerge below the plate 32. The mechanism 36 then raises the punches 14 and the plate 16, so the foil 12 can be fed forward again.

The foil elements 12 are typically secured in a holder, for use. One such type of holder 40 is shown in FIG. 4, consisting of a circular stainless-steel ring with a step 42 in the bore. The element 12 (shown in elevation) fits within the wider part of the circular bore, resting against the step 42, with the upper surface (from which the radiation is emitted) exposed through the narrower part of the circular bore. The element 12 is then secured in position by crimping the wall of the wider part of the bore, as indicated at 44. This crimping may be performed at a number of locations around the wall, preferably at least five, or around the entire wall of the bore. It will be appreciated that the holder 40 is only one type of holder that might be used with the foil elements 12. Another type of holder (not shown) has a blind circular recess on one surface; the element 12 is located into the circular recess with its upper surface exposed, and the walls of the recess are crimped in to fix the element 12 into position in substantially the same way as described above.

It will be appreciated that the hexagonal foil elements may be of a different size to that described above, and may contain a different radioactive material. Furthermore the method of cutting out the foil elements may be different from that described in relation to FIG. 3. For example the hexagonal punches 14 may be arranged as two parallel lines rather than a single line; referring to FIG. 1, alternate punches 14 might be in a position say two hexagons to the left of that shown, so the punches 14 are staggered so as to form two parallel lines. The cutting blade 16 might be spaced further away, say one further hexagon, from the line or lines of punches 14. The punches 14 and the cutting blade 16 might operate alternately rather than simultaneously. Furthermore in place of the end stop 34 there might instead be a linear array of pins (not shown) between the cutting blade 16 and the array of punches 14, the pins fitting between the zigzag edges of the protruding portions of foil; in this case after punching out the hexagonal elements with the punches 14 the foil 10 would be pushed forward so the pins abut against the cut edges of the foil 10 (acting as an end stop), and the blade 16 then activated to cut off the end-most protruding hexagonal elements.

The hexagonal shape of the elements reduces the amount of waste material generated by the cutting out process, because no gaps need be left between adjacent foil elements when cutting. Once mounted in the circular holder the hexagonal edges are hidden by the holder, so there is less area of foil used per source; in comparison, with a circular foil element a larger area of foil is effectively wasted, being concealed by the holder. The resulting source has exactly the same output as would be obtained with a circular foil element, as it is only the exposed part of the element that contributes to source activity.

1. A method of making a multiplicity of radioactive sources (12) from a foil (10) containing radioactive material, characterised by cutting out a multiplicity of hexagonal foil elements (12) from the foil (10), leaving no uncut portions of foil (10) between adjacent hexagonal foil elements (12).

2. A method as claimed in claim 1 comprising first punching out (14) alternate lines of hexagonal foil elements (12), leaving intervening uncut strips with zigzag sides; and then cutting across (16) the uncut strips to form hexagonal foil elements (12).

3. A method as claimed in claim 1 or claim 2 wherein the foil elements (12) are of a laminated metal foil (20, 21, 22).

4. A method as claimed in any one of the preceding claims, further comprising locating the foil element (12) in a recess in a holder (40), and securing the foil in the recess by deforming the adjacent wall (44) of the holder.

5. A method as claimed in claim 4 wherein the recess is circular.

6. A method as claimed in claim 5 wherein the entire circumference of the recess is deformed to secure the foil.

7. A radioactive source made by a method as claimed in any one of the preceding claims.

8. A radioactive source comprising a hexagonal foil element (12) containing radioactive material.
